(19) United States
(12) Patent Application Publication
(10) Pub. No.: US 2008/0111703 A1
(43) Pub. Date: May 15, 2008

(54) Alarm device of twisting bending spanner

(76) Inventor: Chih-Ching Hsieh, Taichung (TW)

Correspondence Address: Chih-Ching Hsieh, Box 8-24, 235 Chung-Ho, Taipei, omitted

(21) Appl. No.: 11/598,273

(22) Filed: Nov. 13, 2006

(51) Int. Cl. G08B 21/00; G08B 5/00

(52) U.S. Cl. 340/665; 340/815.4

(57) ABSTRACT

An alarm device of a twisting bending spanner comprises: a body having an indication light; a handle at one end of the body; a bending tube at another end of the body; a strain gauge being installed in the bending tube; the strain gauge being electrically connected to the indication light of the body. When the force of the spanner applied to an object to be locked or released has achieved to a preset value, the indication light will light up to alert a user. An alarm light is further installed; when the force of the spanner applied to the object is achieved to an alarm value, the alarm light will light up. The body is a hollow body; the handle is soft and a front end of the handle is a toggle; the indication light and alarm light are received in the toggle.

### FIELD OF THE INVENTION

The present invention relates to bending spanners, and particularly to an alarm device of a twisting bending spanner, wherein the strain of the spanner applied to an object can be informed by an alarm light previously and an indication light real time.

### BACKGROUND OF THE INVENTION

In locking or unlocking the screws of the car tires, a bending spanner is used. This is because the screws are installed in the recess of a tire. Thus the straight spanner can not be used since the spanner will has a side adhere to the tire rim and thus it can not be operated effectively.

A bending tube spanner has a bending portion and a head of the bending portion has a rectangular post for engaging with a sleeve. Then the sleeve will enter into the recess of the tire rim for engaging with a screw.

The force for locking nuts of tires to a car is a main concern in the safety of driving, if the force is too great, the nut will be destroyed and if the force is too small, the nut will be destroyed, while this will induce dangerous accidents in driving.

In the prior art bending spanner, no precise strain gauge is installed. The worker determines whether a proper locking is achieved by three sounds in locking the spanner. However this is not an ideal one and thus many traffic accidents occur due to the tires are not well locked.

### SUMMARY OF THE INVENTION

Accordingly, the primary object of the present invention is to provide an alarm device of a twisting bending spanner, wherein the strain of the spanner applied to an object can be informed by an alarm light previously and an indication light real time.

To achieve above objects, the present invention provides an alarm device of a twisting bending spanner comprising: a body having an indication light; a handle at one end of the body; a bending tube at another end of the body; a strain gauge being installed in the bending tube; the strain gauge being electrically connected to the indication light of the body. When the force of the spanner applied to an object to be locked or released is achieved to a preset value, the indication light will light up to alert a user. An alarm light is further installed; when the force of the spanner applied to the object is achieved to an alarm value, the alarm light will light up. The body is a hollow body; the handle is soft and a front end of the handle is a toggle; the indication light and alarm light are received in the toggle. A surface of the toggle has hollowed portions at positions corresponding to those of the indication light and alarm light. The bending tube has scale and a front end of the bending tube is installed with a rectangular post.

The various objects and advantages of the present invention will be more readily understood from the following detailed description when read in conjunction with the appended drawing.

### BRIEF DESCRIPTION OF THE DRAWINGS

FIG. 1 is a perspective view of an alarm device of a twisting bending spanner of the present invention.

FIG. 1A is a partial schematic view about the toggle of the alarm device of a twisting bending spanner of the present invention.

FIG. 2 is a plane view of the indication light of the alarm device of a twisting bending spanner of the present invention.

FIG. 3A is a schematic cross sectional view of the present invention.

FIG. 4 shows the use of the alarm device of a twisting bending spanner of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

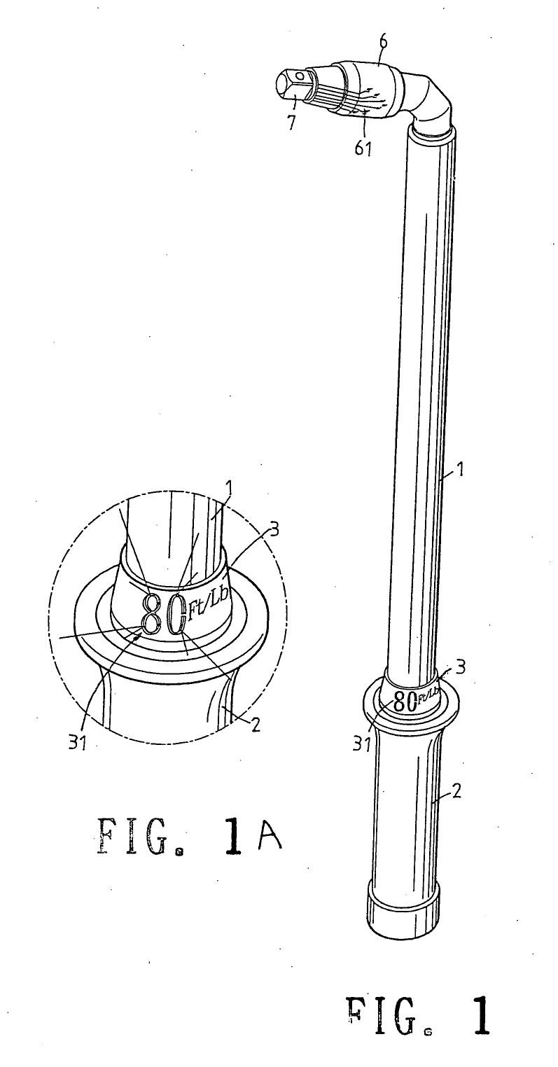

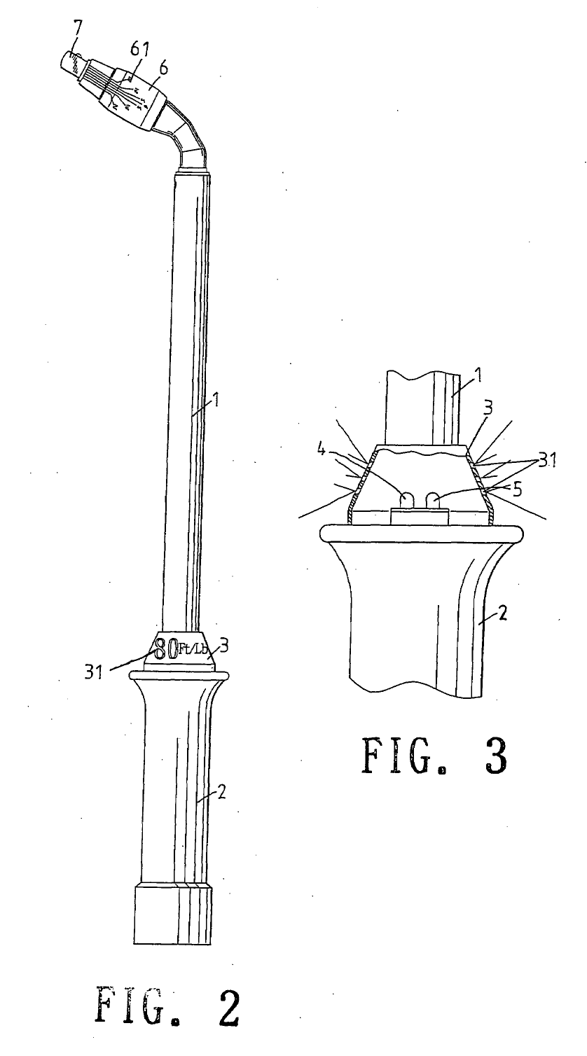

Referring to FIGS. 1 to 3, the alarm device of a twisting bending spanner of the present invention is illustrated. The present invention has the following elements.

A long and hollow tool body 1 is at a middle portion.

A handle 2 is installed at one end of the body 1. A front end of the handle 2 is installed with a tapered toggle 3. An indication light 4 and an alarm light 5 are installed in the toggle 3. A surface of the toggle 3 has hollowed portions 31 corresponding to the portions installed the indication light 4 and alarm light 5 for emitting light.

A bending tube 6 is extended at another end of the tool body 1. A strain gauge (not shown, it is not the main feature of the present invention) is installed in the bending tube 6. The strain gauge is electrically connected to the indication light 4 and alarm light 5 in the toggle 3. A front end of the bending tube 6 is formed with a rectangular connecting post 7.

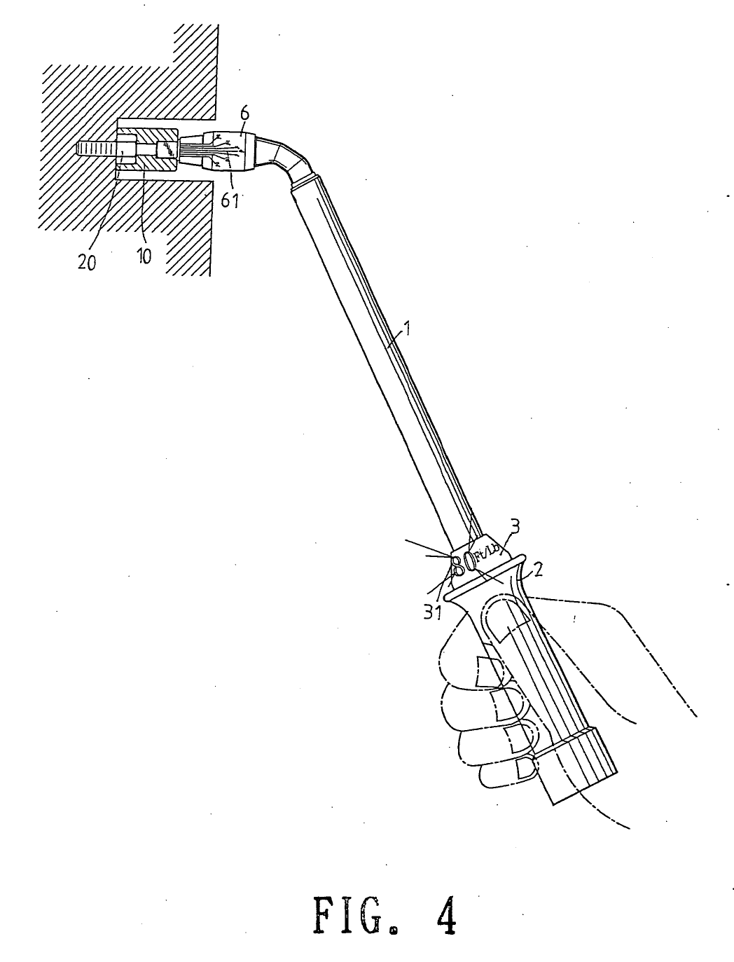

The bending spanner is used to lock or release a tire and the alarm device of a twisting bending spanner can be achieved some effects which will be described herein with reference to FIG. 4. When it is desired to lock a tire to a car body, the sleeve 10 with a proper size is engaged to the rectangular post 7 so as to lock a nut 20. When the strain of the nut has achieved to a predetermined value (it is a value of 90% of a preset strain), the alarm light 5 will light up for alerting the user to keep attention so as to adjust the force applying to the spanner. When the strain has achieved to the preset value, the indication light 4 will light up and the light is transmitted from the hollowed portion 31 so as to inform the user that the twisting force of the nut to the car body has achieved to an optimum value.

Thus, in the present invention, by the indication light 4 and alarm light 5, the user can lock a nut to an optimum state so as to keep the safety in driving. Thus, by the present invention, it can avoid a great locking force to destroy the nut or a small locking force to induce some accidents in driving.

Moreover, in the present invention, a surface of the bending tube 6 can be formed with scales 61 for indicating the value as the preset twisting force is achieved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An alarm device of a twisting bending spanner comprising:
a body having an indication light;
a handle at one end of the body;
a bending tube at another end of the body; a strain gauge being installed in the bending tube; the strain gauge being electrically connected to the indication light of the body; and
wherein when the force of the spanner applied to an object to be locked or released is achieved to a preset value, the indication light will light up to alert a user.

2. The alarm device of a twisting bending spanner as claimed in claim 1, wherein an alarm light is further installed; when the force of the spanner applied to the object is achieved to an alarm value, the alarm light will light up.

3. The alarm device of a twisting bending spanner as claimed in claim 1, wherein the body is a hollow body; the handle is soft and a front end of the handle is a toggle; the indication light and alarm light are received in the toggle.

4. The alarm device of a twisting bending spanner as claimed in claim 2, wherein the body is a hollow body; the handle is soft and a front end of the handle is a toggle; the indication light and alarm light are received in the toggle.

5. The alarm device of a twisting bending spanner as claimed in claim 3, wherein a surface of the toggle has hollowed portions at positions corresponding to those of the indication light and alarm light.

6. The alarm device of a twisting bending spanner as claimed in claim 4, wherein a surface of the toggle has hollowed portions at positions corresponding to those of the indication light and alarm light.

7. The alarm device of a twisting bending spanner as claimed in claim 1, wherein the bending tube has scales and a front end of the bending tube is installed with a rectangular post.

8. The alarm device of a twisting bending spanner as claimed in claim 2, wherein the alarm value is 90% of the preset value.
